(19) United States
(12) Patent Application Publication
(10) Pub. No.: US 2008/0155746 A1
(43) Pub. Date: Jul. 3, 2008

(54) Easy slide

(76) Inventor: Chris Chester Neumeyer, Whitelaw, WI (US)

Correspondence Address: MICHAEL RIES, 318 PARKER PLACE, OSWEGO, IL, 60543, US

(21) Appl. No.: 11/657,969

(22) Filed: Jan. 25, 2007

Related U.S. Application Data
(60) Provisional application No. 60/877,340, filed on Dec. 27, 2006.

(51) Int. Cl. A61G 7/10

(52) U.S. Cl. 5/81.1 R; 5/625

(57) ABSTRACT

The present invention is a method and device for use by EMTs, or paramedics in the process of moving patients, particularly obese patients, onto another support structure, such as a cot, bed, stretcher, gurney or the like. The device is may be formed of rigid PVC or plastic and has a plurality of hand holds. The method and device include dimensions and features which prevent injury to the EMTs, and which provide comfort and support to the patient during the moving process. The device is adapted to be placed under a patient after turning the patient on their side from an initial position, sliding the patient over the device, placing the patient onto the other support structure, and removing the device from under the patient after moving is completed.

This application claims the benefit of U.S. Provisional Patent Application Ser. No. 60/877,340, filed Dec. 27, 2006.

### TECHNICAL FIELD AND BACKGROUND OF THE INVENTION

The present invention generally pertains to transfer boards. More specifically, the present invention relates to a transfer board to move patients between adjoining surfaces such as from a transport cot to a bed or bed to transport cot.

Some of the most common injuries that occur as an Emergency Medical Technician (EMT) are back and shoulder injuries from the transferring of patients from a bed to the ambulance cot or from the cot to a bed. These injuries can happen when lifting patients of any weight and size. However many times the patients that need the most help in transfers are very obese. Back and shoulder injuries could end an EMT's career and cost the employer a significant amount of money in lost time, compensation, and the significant loss of investment the company has devoted to the employee in training and experience.

A second purpose of Easy Slide the present invention is for improved patient comfort and safety when transferring a patient from cot to bed or bed to cot. The method of moving a patient by blanket carry is jerky. At times it is painful for the patient, could aggravate the patient's injuries, and cause further anxiety. The smooth motion of sliding the patient is a gentler and a calmer transfer that makes the move less traumatic. Easy Slide can be used in a hospital or clinic setting for transferring patients during exams or diagnostic imaging.

With the use of “Easy Slide” the patient is rolled to his/her side and Easy Slide is then slid under the patient's side. The patient is then rolled on his/her back onto Easy Slide and then the patient is slid over to the cot or bed. Easy Slide is then removed from under the patient by sliding it out from under the patient. This is accomplished with a fraction of the effort that would be needed by using the method of a blanket lift thus possibly preventing a back or shoulder injury to the people doing the transfer and making the move less traumatic for the patient.

The simplicity of Easy Slide is what makes it such a valuable tool to use for the above mentioned. It's size allows for easy carrying and the ability to be stowed on an ambulance cot at the foot end. It's flexibility does not hamper elevating the legs or head when needed and allows smooth movement when patient transfer is over less than smooth surfaces. The hand holds makes it easy to remove it from under the patient and the center hand hold is centered for balance when carrying. It should be mentioned Easy Slide is not for lifting patients. It's structure is not designed as such and without the patient being strapped to the board there is the possibility of the patient sliding off or the people lifting the patient could loose their balance. This device is designed for sliding the patient only.

Easy Slide is made out of a poly vinyl chloride, ultra high molecular weight, very high molecular weight or a plastic that has some flexibility so as not to be brittle and susceptible to cracking during use. It has three hand holds for carrying and for an easy grasp to slide the board out from under the patient when the transfer is complete. The size makes it possible to have the Easy Slide whenever the cot is brought to the scene making another trip to the ambulance for more equipment less likely.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a drawing of a top view of an easy slide transfer board, in accordance with one embodiment of the present invention;

FIG. 2a illustrates a drawing of an end view of a cot and a bed with a patient on the bed being rolled on their side, in accordance with one embodiment of the present invention;

FIG. 2b illustrates a drawing of an end view of a cot and a bed with a patient on the bed stating to be moved in a direction of a cot while on an easy slide, in accordance with one embodiment of the present invention;

FIG. 2c illustrates a drawing of an end view of a cot and a bed with a patient in between a bed a cot while on an easy slide, in accordance with one embodiment of the present invention

FIG. 2d illustrates a drawing of an end view of a cot and a bed with a patient on a cot, in accordance with one embodiment of the present invention.

FIG. 2e illustrates a drawing of an end view of a cot and a bed with a patient on a cot being rolled, tipped or slightly lifted to one side to remove an easy slide, in accordance with one embodiment of the present invention

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “one embodiment” is used repeatedly. The phrase generally does not refer to the same embodiment, however, it may. The terms “comprising”, “having”, composing” and “including” are synonymous, unless the context dictates otherwise.

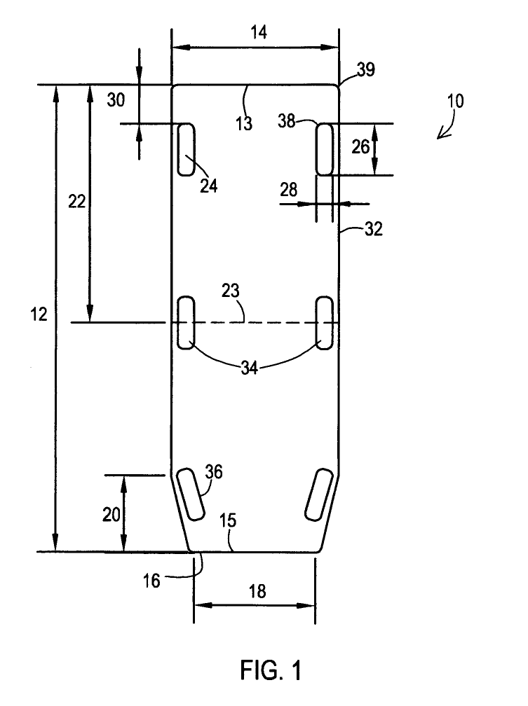

Referring now to FIG. 1 illustrating a drawing of one embodiment of an easy slide or transfer board 10. The Easy Slide 10 has a thickness in the range of ⅛ to ⅝ of an inch. A total length 12 of the board 10 is in a range of 40 to 80 inches and a non tapered end 13 has a width 14 in a range of 12 to 24 inches with a tapered end 15 has a width 18 in a range of 10 to 13 inches. Tapered end 15 begins to taper a taper distance 20 in a range of 5 to 10 inches from the tapered end 15. Centerline 23 is a center line distance 22 which is half of the total length 12 and measured from either the non tapered end 13 or tapered end 15 into the centerline 23, total length 12 being the distance between the non tapered end 13 and tapered end 15.

In FIG. 1 hand holes 24 are cut to a hand hole length 26 in a range 3½ to 5½ inches and a hand hole width 28 in a range 1 to 2 inches. Hand holes 24 are a set back distance 30 in a range of 1 to 2 inches from an outside edge 32 of the board 10. There may be three to five hand holes 24 on each side of the board 10. A center pair of hand holes 34 are centered on centerline 23. Non tapered end hand holes 36 and tapered end hand holes 38 are an end distance 35 in a range of 3 to 5 inches in from non tapered end 13 and tapered end 15 respectively. All hand holes are rounded with an inside radius 36 of 9/16 inch. All outside corners 39 of the board are rounded in a range of ¼ to ¾ inch radius.

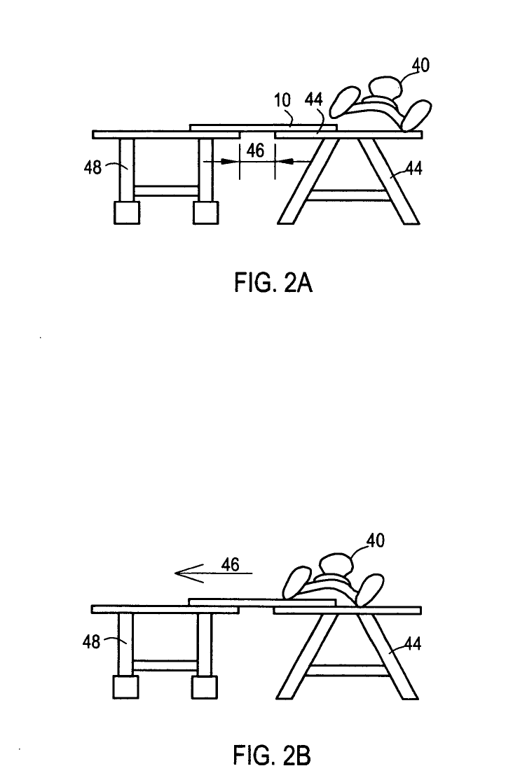

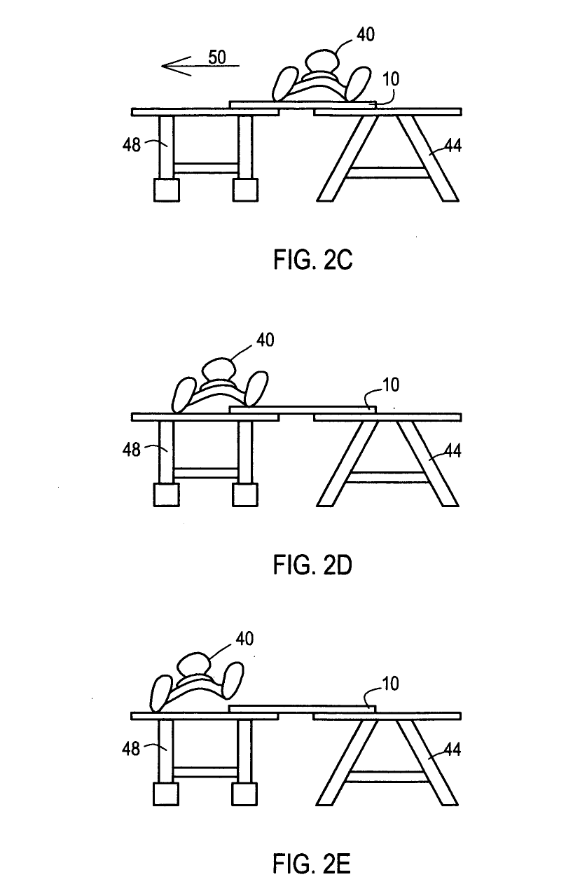

FIG. 2a, illustrates one embodiment of an easy slide 10. Patient 40 is rolled to their side and easy slide 10 is placed half way or partially 42 under patient 40. Bed 44 is where the patient needs for be moved from. Easy slide 10 bridges a gap 43 between bed 44 and cot 48. FIG. 2b shows patient 40 back to a flat position and the patient 40 is being moved in the direction 46 of cot 48. FIG. 2c shows patient 40 in between the cot 48 and bed 44 on easy slide 10 being moved 50 towards the cot 48. It is understood that the patient 40 may be moved over easy slide 10 using the typical blanket lift and slide. It is also understood that the patient 40 may be moved over easy slide 10 by carefully pushing or pulling the patient 40. Easy slide 10 bridges gap 43 to reduce stress and strain to an EMT because the EMT can let easy slide 10 take some of the weight of the patient 40. FIG. 2d shows patient 40 comfortably on cot 48 without any injuries from the move. In FIG. 2e the patient 40 is again rolled, tipped or slightly lifted to one side so that easy slide 10 can be removed from under patient 40.

While the present invention has been related in terms of the foregoing embodiments, those skilled in the art will recognize that the invention is not limited to the embodiments depicted. The present invention can be practiced with modification and alteration within the spirit and scope of the appended claims. Thus, the description is to be regarded as illustrative instead of restrictive on the present invention.

What is claimed is:

1. A transfer board comprising:
at least three hand holes; and
a first and second side that allow connection to a bed or cot to allow a patent to be moved from cot to bed with little or no disturbance to the patient.

2. The board of claim 1 wherein the transfer board is made of a selected one of poly vinyl chloride, ultrahigh molecular weight, high density polyethylene or plastic with some flexibility.

3. The board of claim 1 wherein the board has 6 to 10 hand holes.

4. The board of claim 3 wherein the each hand hole is 3½ to 5½ inches long 1 to 2 inches wide and 1 to 2 inches from an edge of the board.

5. The board of claim 1 wherein the board has a selected one of a tapered end and square end.

6. The board of claim 5 wherein the tapered end is 10 to 13 inches wide and tapers 5 to 10 inches back.

7. The board of claim 1 wherein the board has a non tapered end that is 12 to 24 inches wide.

8. The board of claim 1 wherein the board has a length of 40 to 80 inches.

9. The board of clam 1 wherein the board has a centerline at 20 to 40 inches from each end.

10. The board of claim 1 wherein the board has two center hand holes centered on a centerline.

11. The board of claim 1 wherein the board has 4 end hand holes 2 to 6 inches from each end.

12. A method of moving a patient comprising:
rolling a patient on a first side;
placing an easy slide under the patient;
moving the patient on the easy slide from a first location to a second location; and
removing the easy side from under the patient.

13. The method of claim 12 wherein the easy slide is made of a selected one of poly vinyl chloride or plastic with some flexibility.

14. The method of claim 12 wherein the easy slide has 6 to 10 hand holes.

15. The method of claim 14 wherein the each hand hole is 3½ to 5½ inches long 1 to 2 inches wide and 1 to 2 inches from an edge of the board.

16. The method of claim 12 wherein the easy slide has a selected one of a tapered end and a square end.

17. The method of claim 16 wherein the tapered end is 10 to 13 inches wide and tapers 5 to 10 inches back.

18. The method of claim 12 wherein the easy slide has a non tapered end that is 12 to 24 inches wide and the easy slide has 4 end hand holes 3 to 5 inches from each end.

19. The method of claim 12 wherein the board has a length of 40 to 80 inches and the board is ⅛ to 5/16 inch thick.

20. The method of claim 12 wherein the easy slide has a centerline at 20 to 40 inches from each end and the easy slide has two center hand holes centered on a centerline.
